(19) United States
(12) Patent Application Publication
(10) Pub. No.: US 2007/0096457 A1
(43) Pub. Date: May 3, 2007

(54) ARTICLES INCLUDING REMOVABLE CONCEALING LAYERS AND METHODS OF PRINTING THE SAME

(75) Inventor: Bill Cahill, Eagan, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: TRAVEL TAGS, INC., North Mankato, MN (US)

(21) Appl. No.: 11/555,529

(22) Filed: Nov. 1, 2006

Related U.S. Application Data
(60) Provisional application No. 60/733,138, filed on Nov. 3, 2005.

(51) Int. Cl. B42D 15/00

(52) U.S. Cl. 283/72

(57) ABSTRACT

A system and method of printing articles including removable concealing areas. To efficiently produce a printed article with concealed areas of high print quality, an inkjet printing process, preferably drop on demand (DOD) inkjet printing, is used to create a raised printed area. To adequately conceal printed areas, a clear doming material is applied over the printed area before concealing. The clear doming material covers or fills any raised printed areas to create a level surface for subsequent application of a concealing layer. In one embodiment, a hot foil stamping method is used to produce a scratch-off concealing layer. Upon scratching or abrading by the end consumer, the concealing layer is removed to reveal the printed area.

### RELATED APPLICATION

This application claims the benefit of U.S. Provisional Application No. 60/733,138, filed Nov. 3, 2005, which is incorporated herein by reference in its entirety.

### FIELD OF INVENTION

The invention relates generally to printing and printed articles. More particularly, the invention relates to printed articles including removable concealing layers and methods of printing such articles.

### BACKGROUND OF INVENTION

In some applications, it is desirable to conceal some or all of the printing or indicia on an article. The printing is often concealed by an opaque layer, such as a thin foil or ink, that can later be easily removed. The removable concealing layer may be applied as a security feature, such as to conceal a personal identification number (PIN), or as a novelty or combination thereof, such as on a scratch-off game piece. In one known application, removal is easily accomplished by scratching off the thin foil covering. Examples of articles that often include scratch-off concealed areas include gift cards, coupons, lottery tickets, game pieces, telephone calling cards, postcards, and other similar articles.

In one particular example, a printed telephone calling card may contain a PIN number to be revealed upon first use after purchase. The PIN number may be covered by a removable opaque concealing layer that can be removed by scratching, abrading, or some other similar process. In general, the removable concealing layer must be substantial enough to withstand handling prior to purchase of the card and a desired time of removal but relatively easy to remove for use when desired.

Printing methodologies used to produce articles that include selectively removable concealing areas are known in the industry. Flexography, lithography, inkjet, laser, variable digital, thermal imaging, silk screening, and other printing methodologies can be used to print on a substrate. A removable concealing layer is then applied over some or all of the printed areas. Such concealing layers can be a hot stamp foil, including pigment and metallic foils; opaque inks, including flexographic, lithographic, and silk screen inks; films; covered or coated labels; wax materials; adhesive-type materials; and other suitable concealing layers. Removable concealing layers are often applied by methods such as hot stamping, adhesives, additive printing methodologies, and other suitable methods. The removable concealing layer can be subsequently removed by means of scratching, abrading, and the like. In one example, a clear label coated with a removable opaque ink is applied over a printed area to be concealed. The ink can be easily removed and the printed area revealed, visible through the clear label that remains.

The manufacturing methods described above suffer from a number of disadvantages. For example, thermal imaging printing is frequently used in creating printed articles having removable concealed areas. Although thermal imaging printing generally produces high quality results, it is a slow process and output rates are lower when compared to alternative printing methods. Inkjet printing, on the other hand, is a faster, more efficient process, but produces relatively poor print quality compared to thermal imaging.

Some types of inkjet printing, particularly drop-on-demand (“DOD”) inkjet printing, produce print quality that is similar to thermal imaging at a high output rate. However, DOD printing produces a firm raised image upon curing. Referring to FIG. 1, upon application of a removable concealing layer 10 over DOD printing on a phone card 2, a raised image 12 is apparent through the opaque layer. The purportedly concealed area remains viewable and/or tactilely discernable and thus is not completely concealed.

Accordingly, there remains a need for high quality, efficiently produced printed articles having removable concealing layers that provide sufficient concealment.

### SUMMARY OF THE INVENTION

The invention resolves many of the above-described deficiencies and drawbacks inherent with printing high quality printed articles having removable concealing areas. In particular, one embodiment of the invention is directed to a system and method of printing a substrate according to an inkjet printing methodology, applying a clear doming layer to level a printed area, and applying a removable concealing layer over the clear doming layer and printed area.

Various embodiments of the invention disclosed and described herein incorporate inkjet printing methods such as drop-on-demand (“DOD”) printing to create relatively high quality images at a high output rate as compared to other printing techniques. Because the cured DOD printed indicia results in a raised, visually and/or tactilely discernable area, the raised area is subsequently covered by applying a clear material as a doming layer without distorting or degrading the underlying printed indicia. In one embodiment, the doming layer can be applied in a flood or solid area to fill in the raised area. In another embodiment, the doming layer can be applied in a non-solid pattern to sufficiently mask or deceive the underlying indicia such that the indicia are no longer discernable. The doming layer can be applied by various additive printing methodologies, extrusion, or other suitable means. A removable concealing layer, such as a hot stamped foil, is then applied over the optionally cured doming layer and printed indicia. The printed indicia are therefore sufficiently concealed and inconspicuous. Upon use, the removable concealing layer can be removed by scratching, abrading, or other suitable methods of revealing the underlying printed indicia.

The above summary of the invention is not intended to describe each illustrated embodiment or every implementation of the present invention. The figures and the detailed description that follow more particularly exemplify these embodiments.

### BRIEF DESCRIPTION OF THE DRAWINGS

FIG. 1 is a perspective view of a prior art phone card with discernable printed indicia.

FIG. 2 is a perspective view of one side of a printed article according to one embodiment of the invention.

FIGS. 3A, 3B, and 3C are cross-sectional layer diagrams according to embodiments of the invention.

FIG. 4 is a block diagram of a printing process according to one embodiment of the invention.

FIG. 5 is a flowchart of a method according to one embodiment of the present invention.

FIG. 6 is a layer diagram of a lenticular printed article according to one embodiment of the invention.

### DETAILED DESCRIPTION OF THE DRAWINGS

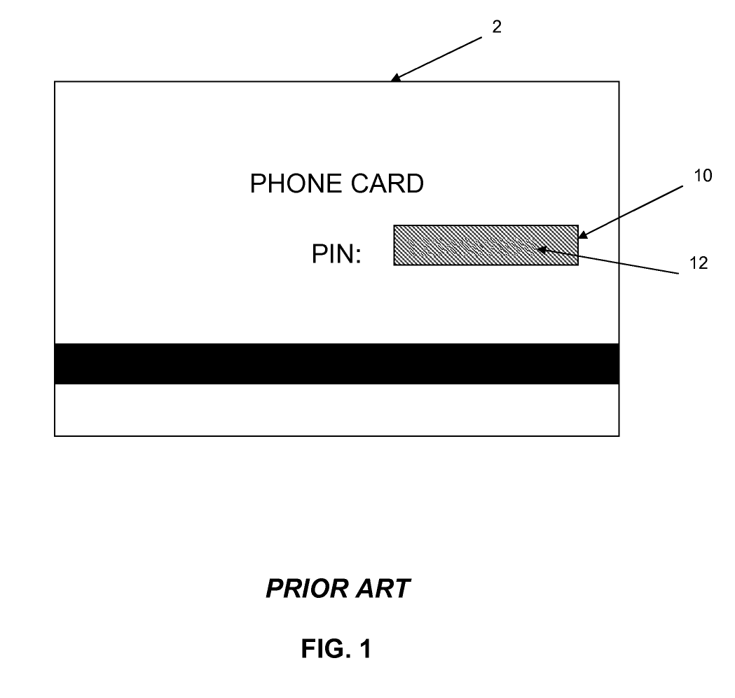

The invention includes printed articles with removable concealing areas. The printed articles are of a high print quality and attractive appearance and can be efficiently produced according to methods and printing processes and systems of various embodiments of the invention described herein. The printed articles, methods, and printing processes and systems are described in more detail below with reference where applicable to FIGS. 1-6.

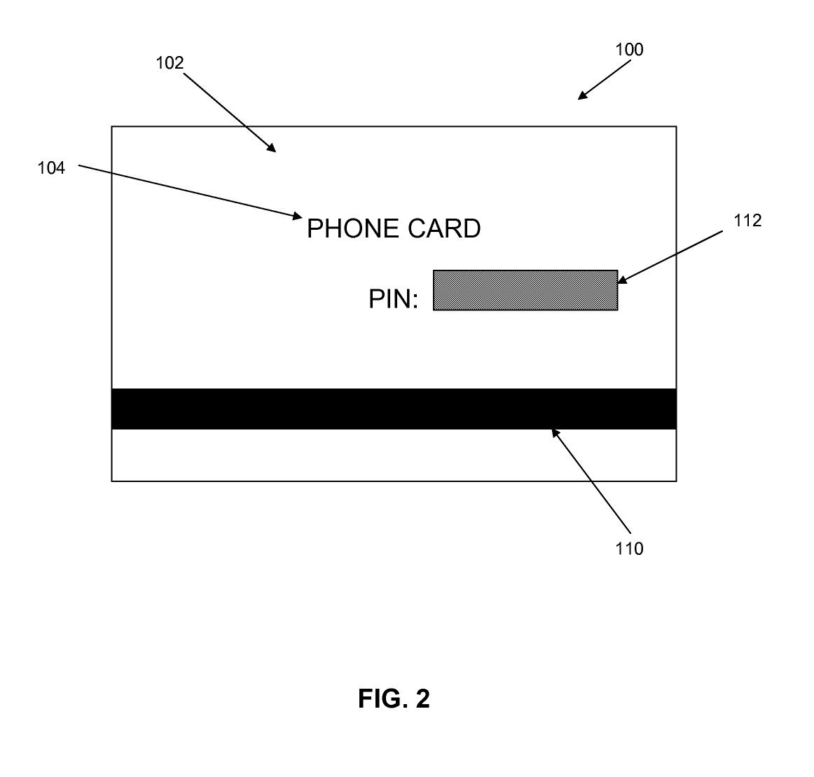

One side of a printed article including a removable concealing area is shown generally in FIG. 2. Printed article 100, depicted in FIG. 2 as a phone card, can also comprise a gift card, coupon, lottery ticket, game piece, advertisement, debit card, credit card, postcard, mailer, and virtually any other article or object on which concealed printing is desired. Printed article 100 therefore generally comprises a substrate 102, printed indicia 104, and concealed area 112 concealing additional printed indicia. Printed article 100 can be two-sided, including printed indicia 104 on both sides of substrate 102, although only a single side is shown in FIG. 2. Printed article 100 can also optionally comprise a magnetic stripe 110 on either side of substrate 102 for encoding information such as the value of a gift card, identifying information, access privileges, and other suitable information.

Other attributes can be added to printed article 100 on either side of substrate 102 as desired, such as bar coding, encrypted bar coding, radio frequency identification (RFID) tags, and other identifiers and indicia. Further, it can be appreciated that certain illustrated features, such as concealed area 112 and magnetic strip 110, need not be included on the same surface of substrate 102 or can be included on both major surfaces of substrate 102. Printed article 100 will often include printed indicia 104 on both major surfaces of substrate 102.

Substrate 102 can comprise plastic, laminated plastic, paper, coated paper, laminated paper, laminated synthetic paper, cardstock, foil, and other suitable substrates for printing and can comprise a sheet, web, card, or other form prior to and during printing. Printed indicia 104 can comprise text, numbers, pictures, drawings, symbols, and other indicia that can be printed on a substrate. Printed indicia 104 can comprise curable inks in a variety of colors and effects, such as a metallic appearance in one embodiment, although non-curable inks can be used in other embodiments. To accomplish high quality printing at an efficient output, inkjet printing can be used to apply indicia 104 to substrate 102 in one embodiment. For example, a curable inkjet printing methodology, such as a radiation curable inkjet printing methodology, a UV curable inkjet printing methodology, a drop-on-demand (“DOD”) inkjet printing methodology, or a radiation curable DOD inkjet printing methodology can be used to print indicia 104 on substrate 102 in various embodiments of the invention described in more detail below. Other printing methodologies or a combination of printing methodologies can also be used in other embodiments of the invention.

DOD printing methodologies can be used to print all or only part of indicia 104 and any indicia concealed by concealing layer 108. Referring to FIG. 1, the properties of DOD ink generally result in firm raised printed areas 12 on the substrate, particularly after curing. Examples of suitable DOD inks include black, red, blue, and other custom colors of DOD inkjet inks commercially manufactured by Sun Chemical or Graphtech. The appearance of DOD printed areas is therefore of a high quality and attractive appearance but has heretofore been incompatible with hot stamp foil concealment because of the resultant three-dimensional printed area.

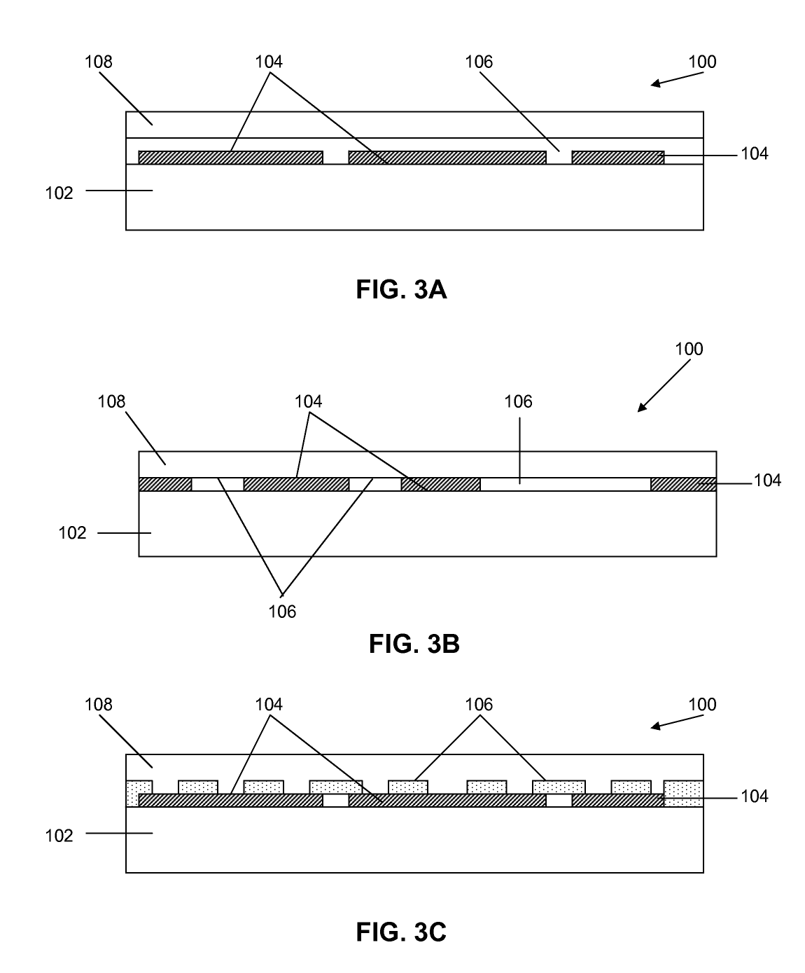

Referring to FIGS. 3A, 3B, and 3C, printed indicia 104 form a plurality of raised areas relative to substrate 102. To adequately conceal desired indicia 104 on printed article 100, a filler or doming layer 106 is subsequently applied to substrate 102 over printed indicia 104. In one embodiment, doming layer 106 creates a level area for subsequent application of removable concealing layer 108. For example, if the raised areas of printed indicia 104 have a height relative to a surface of substrate 102, an application of doming layer 106 can be within +/−50 percent of the height of printed indicia 104, preferably within +/−25 percent of the height of printed indicia 104, more preferably within +/−10 percent of the height of printed indicia 104, to adequately conceal printed indicia 104, maintain an attractive appearance of printed article 100, and minimize waste of material of doming layer 106.

In another embodiment, doming layer 106 is applied in a pattern to mask or obscure indicia 104 such that indicia 104 is not visually or tactilely discernable. In yet another embodiment, doming layer 106 and removable concealing layer 108 comprise a single layer. In this embodiment, the single layer is sufficiently thick, is applied in an obscuring pattern, or has other properties, such as described in more detail below, to adequately tactilely and/or visually obscure printed indicia 104.

Doming layer 106 can comprise a clear or substantially transparent material that does not distort or itself conceal printed indicia 104. In some embodiments, doming layer 106 can comprise a clear curable ink applied by an additive printing methodology, such as flexography, inkjet printing, and the like. In other embodiments, doming layer 106 can comprise an extruded film or material that remains clear upon curing. Doming layer 106 can also be semitransparent, opaque, or substantially opaque in other embodiments. In yet another embodiment in which doming layer 106 and removable concealing layer 108 comprise a single layer, the single layer can be colored or tinted and/or can comprise granules, fibers, flakes, particles, and/or other texturizers to obscure printed indicia 104. Suitable materials for doming layer 106 may include but are not limited to a clear UV silkscreen carrier, a clear UV varnish or coating, a clear aqueous coating, a solvent or water-based clear coating, a radiation curable clear coating, an adhesive, a pressure sensitive adhesive, a radiation curable adhesive, a wax material, and a UV screen matte doming compound commercially manufactured by Rad-Cure.

As depicted in FIG. 3A, doming layer 106 can comprise a continuous layer completely covering printed indicia 104 and filling in any recesses. As depicted in FIG. 3B, doming layer 106 can also be applied to only fill in the recesses of printed indicia 104. As depicted in FIG. 3C, doming layer 106 can also be applied in a regular or irregular pattern to mask or obscure indicia 104 such that indicia 104 is no longer visually or tactilely discernable. Doming layer 106 can be locally applied over only indicia 104 desired to be concealed, although doming layer 106 can also be applied over an entire surface of substrate 102 for a desired effect.

Removable concealing layer 108 typically applied over doming layer 106 can comprise an opaque material, such as, for example, a foil, including hot stamp, pigment, and metallic foils; opaque inks, including flexographic, lithographic, and silk screen inks; films; foil or ink coated labels; wax materials; adhesive-type materials; and other suitable opaque materials, to temporarily conceal printed indicia 104 until selective removal. In one embodiment of the invention, removable concealing layer 108 comprises a hot stamp foil that is frictionally removable, such as by scratching or abrading. Removable concealing layer 108 can be of a variety of colors and/or attractive metallic and other finish effects.

Removable concealing layer 108 is applied over doming layer 106, and can be uniformly applied or applied in a pattern or other concealing or obscuring manner. Removable concealing layer 108 can comprise, for example, a hot foil scratch-off material; a metallic or pigment hot foil scratch-off material; a label coated with a scratch-off ink or other material; a UV or radiation cured varnish or coating followed by silkscreen, flexographic, or lithographic ink; extruded inks, adhesives, waxes, or other extruded materials; or radiation cured extruded inks, adhesives, waxes, or other materials. Removable concealing layer 108 can further comprise an opaque ink, flexographic ink, lithographic ink, silk screen ink, film, foil-coated label, ink-coated label, and/or adhesive material that is radiation curable, solvent-based curable, or water-based curable. Removable concealing layer 108 can also be of a solid color, a combination of colors, or some other form.

In another embodiment, removable concealing layer 108 comprises a scratch-off foil material applied onto or over one surface of a clear or tinted label. The label can be applied over doming layer 106 by hot stamping, adhering, or other attaching means and remains after the foil layer is removed, allowing the printed indicia 104 to be viewed. In yet another embodiment, the aforementioned label comprises doming layer 106 is applied over printed indicia 104, and removable concealing layer 108 comprises the scratch-off foil material applied onto or over one surface of the label, as mentioned above.

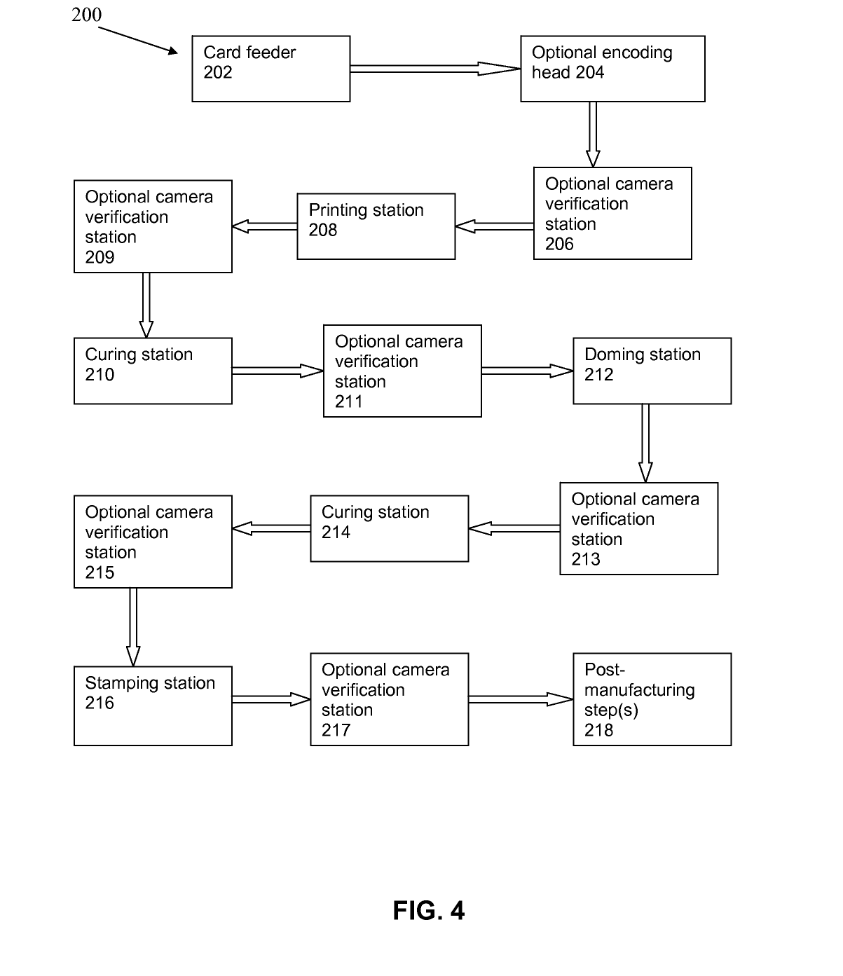

Printed articles 100 can be produced in a continuous in-line process or in a series of batch processes located at the same location or various locations. In one embodiment of the invention, as depicted in FIG. 4, concealed printing articles 100 are manufactured in a continuous process 200 comprising a series of in-line stations or manufacturing stages. Prior to process 200, one or more optional preprocessing or preproduction stages may occur, including printing, cutting, forming, coating, treating, trimming, or any other pre-process desired or required to prepare article 100, including substrate 102. Substrate 102 can comprise a continuous web, sheets, or individual articles 100. In the example embodiment of FIG. 4, article 100 comprises individual preformed cards, such as card 100, fed by a card feeder 202. In other embodiments, card feeder 202 instead comprises a sheet feeder, web roll handler, or other specialized feeder. Cards 100 are moved through process 200 by a belt, chain, or other suitable transporting means.

In one embodiment, cards 100 pass through an optional encoding head 204 which encodes a magnetic strip 110 on cards 100. Magnetic strip 110 can be pre-applied to cards 100 or, although not depicted in FIG. 4, can be applied as part of process 200. In another embodiment, optional encoding head 204 is omitted for articles 100 not comprising a magnetic strip or for articles including magnetic strips that are encoded outside of process 200. In yet another embodiment, encoding takes place at a different point within process 200.

Encoding head 204 is followed by a printing station 208. Printing station 208 comprises an inkjet printing system, such as a DOD inkjet printing station, in one embodiment, although other or additional suitable printing systems can be used in other embodiments. Suitable DOD inkjet printing systems are commercially available from Atlantic Zeizer and CPST, for example. Suitable DOD inkjet heads are commercially available from Graphtech. An ink, such as a radiation or UV curable or other suitable ink, is deposited onto one or both sides of card 100 at printing station 208 to create printed indicia 104, indicia to be concealed, and other printed content. Cards 100 can optionally include preexisting printed content applied during one or more optional preprocessing stages as previously discussed.

Printed indicia 104 can be cured at cure station 210. Cure station 210 can comprise radiation curing, such as UV, electron beam, gamma radiation, and other suitable radiation curing methods known in the industry. Cure station 210 can comprise more than one curing step of the same type or a combination of radiation or other curing units. In another embodiment of the present invention, printed indicia 104 can be cured by thermal energy such as infrared (IR), heat, and the like at cure station 210. In yet another embodiment of the present invention, cure station 210 can comprise a combination of radiation and thermal energy curing units.

After cure station 210, printed cards 100 move to doming station 212. In some embodiments, doming station 212 can comprise an additive printing methodology, such as, for example, flexography, inkjet, and other additive printing methodologies. In other embodiments, doming station 212 is an extrusion process incorporating an extruder and an extrusion die. A thin layer of suitable clear doming material as described above is deposited onto printed card 100 to form doming layer 106 over some or all of card 100. As previously discussed, doming layer 106 can be a continuous flood layer that fills in or completely covers the underlying printing, or a selectively applied pattern to mask or sufficiently obscure the underlying printing such that the printing is difficult or impossible to distinguish.

Doming layer 106 is then cured at cure station 214. Cure station 214 can comprise more than one curing of the same type or a combination of radiation curing units as described above with reference to cure station 210.

Card 100 then enters stamping station 216. In one embodiment, stamping station 216 comprises a hot stamp process that utilizes a heated die in combination with pressure to stamp a concealing layer 108, such as a foil, foil label, and other suitable concealing materials as described above, onto printed card 100 where it is desired to conceal some or all of printed indicia 104. A suitable hot foil unit is commercially available from Atlantic Zeizer. Stamping station 216 may be followed by an optional cure station (not shown) similar to cure stations 210 and 214 described above.

Printed article 100 then moves to optional post-processing step(s) 218. Post-processing can include one or more cutting, trimming, affixing to a carrier, encoding, coating, sealing, converting, sorting, stacking, and/or packaging, stages, as well as other additional post-processes if desired. Optional post-processing step 218 is typically not in-line with, i.e., on the same machine as, the others steps of process 200.

In various embodiments of the invention, at least one camera verification station can be positioned throughout in-line process 200. As depicted in FIG. 4, optional camera verification stations 206, 209, 211, 213, 215, and 217 are located after encoding head 204, printing station 208, curing station 210, doming station 212, curing station 214, and stamping station 216, respectively. Any combination of optional camera verification stations 206, 209, 211, 213, 215, and 217, or more or fewer stations, can be placed throughout process 200 to monitor and verify processing and progress within process 200.

In other alternate embodiments of the present invention, a plurality of printing units can be stationed at printing station 208. For example, a combination of inkjet and/or DOD inkjet printing heads can be used for different colors, different inks, or other applications. In other embodiments, a combination of printing methodologies including or excluding at least one inkjet or DOD inkjet printing head can be used at printing station 208 to print substrate 102. In another embodiment of the present invention, multiple printing stations 208 and curing stations 210 and combinations thereof can be located throughout process 200.

In embodiments of process 200, at least 5,000 or more high quality printed articles 100, such as gift, debit, credit, or phone cards, can be produced in-line per hour. The rate will vary according to the size and production complexity of the printed articles and related variations in process 200, as can be appreciated by those skilled in the art. The print quality is typically better than ordinary inkjet and comparable with that provided by thermal imaging printing methodologies.

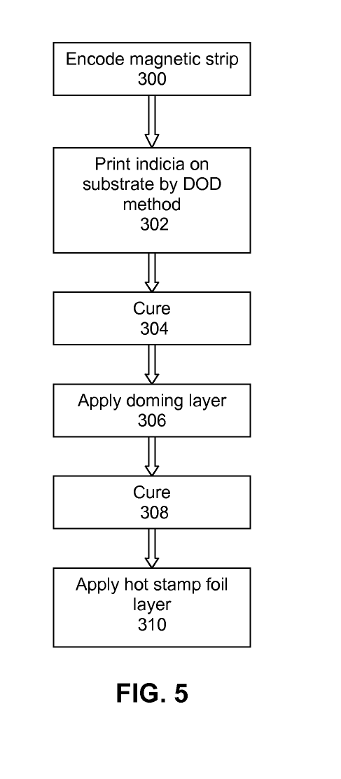

Referring to FIG. 5, and in one embodiment of a method of the invention, printed article 100 can be manufactured in a continuous in-line process in a series of steps, such as process 200 of FIG. 4. In step 300, a magnetic strip on substrate 102 is encoded. Encoding can also take place at an alternate point in the process. Indicia 104 is then printed on substrate 102 according to a DOD inkjet printing methodology in step 302 and optionally cured at step 304 to created printed indicia 104. A doming layer 106 is applied over printed indicia 104 in step 306, and subsequently optionally cured in step 308. Removable concealing layer 108 is applied over doming layer 106 and printed indicia 104 and optionally cured in step 308 to create concealed printing article 100.

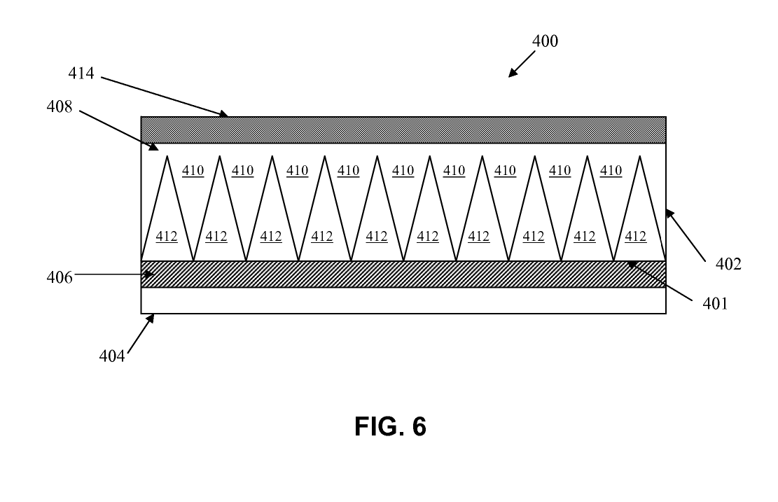

In another embodiment of the invention, printed article 100 comprises a lenticular article 400 including a lenticular lens layer 402 as depicted in FIG. 6. Lenticular article 400 can comprise a sheet, card, label, insert, jacket, wrap, cup, cylinder, container, or other item suitable for displaying a lenticular image. Similar to as described above, indicia can be mapped and printed onto some or all of flat surface 401 of lenticular lens layer 402 or onto a substrate layer 404 of lenticular article 400 to create a printed indicia layer 406. A suitable doming material, label, or layer is then applied to some or all the lens layer 402 of lenticular lens 400 to fill in or cover the valleys 410 between ridges 412 and create doming layer 408. A removable concealing layer 414, such as a scratch-off hot stamp foil as described herein above, is applied over some or all of doming layer 408 and to conceal printed indicia layer 406 visible as a lenticulated image through lens layer 402. Upon scratching or abrading to remove concealing layer 108, printed indicia layer 406 is visible as a lenticulated image through lenticular lens layer 402.

Printed indicia layer 406 can also be printed directly onto lenticular lens layer 402. Doming layer 408 can then be applied over printed indicia layer 406 on lenticular lens layer 402, followed by removable concealing layer 108. Upon scratching or abrading to remove concealing layer 108, printed indicia layer 406 is visible on lens layer 402.

Alternatively, printed indicia layer 406 can be applied onto doming layer 408 applied over lenticular lens layer 402. Upon scratching or abrading to remove concealing layer 108 applied over printed indicia layer 406 on doming layer 408, printed indicia layer 406 is visible on doming layer 408. Doming layer 408 can be clear or semitransparent in order to view an underlying lenticulated image, or doming layer 408 can be opaque to obscure any underlying lenticulated image and possibly make viewing of printed indicia layer 406 easier.

In yet another embodiment similar to that depicted in FIG. 6, indicia is printed on a top surface of lenticular lens 400, in addition to or instead of on surface 401 or substrate 404. A filler layer or label is first applied to lens 400 to fill in or cover valleys 410 between ridges 412 to create a printing surface. Indicia is then printed over the filler layer, followed by application of a doming layer or label over the indicia. A removable concealing layer is then applied over the doming layer to cover or obscure the printed indicia.

The invention therefore addresses and resolves many of the deficiencies and drawbacks inherent with printing high quality printed articles having removable concealing areas. The invention may be embodied in other specific forms without departing from the essential attributes thereof, therefore, the illustrated embodiments should be considered in all respects as illustrative and not restrictive.

1. An article comprising:
a substrate comprising a first surface;
indicia printed on at least a portion of the first surface;
a doming layer applied over at least a portion of the indicia; and
a removable concealing layer applied over at least a portion of the doming layer.

2. The article of claim 1, wherein the indicia comprises inkjet printed indicia.

3. The article of claim 2, wherein the inkjet printed indicia comprises drop-on-demand (DOD) printed indicia.

4. The article of claim 3, wherein the DOD printed indicia comprises a curable ink.

5. The article of claim 4, wherein the curable ink comprises a radiation curable ink.

6. The article of claim 2, wherein the inkjet printed indicia comprises a curable ink.

7. The article of claim 6, wherein the curable ink comprises a radiation curable ink.

8. The article of claim 1, wherein the indicia has a height relative to the first surface and the doming layer is adapted to tactilely obscure the indicia.

9. The article of claim 8, wherein a thickness of the doming layer is within about +/−50 percent of the height of the indicia.

10. The article of claim 9, wherein a thickness of the doming layer is within about +/−25 percent of the height of the indicia.

11. The article of claim 10, wherein a thickness of the doming layer is within about +/−10 percent of the height of the indicia.

12. The article of claim 8, wherein the doming layer is applied over at least a portion of the indicia in a continuous layer.

13. The article of claim 8, wherein the doming layer is applied over at least a portion of the indicia in a non-continuous layer comprising a pattern.

14. The article of claim 1, wherein the doming layer comprises a material selected from the group consisting of: a semi-transparent material; an opaque material; a tinted material; an ink; a clear curable ink; an extruded film; a clear UV silkscreen carrier, a clear UV varnish; a clear UV coating; a clear aqueous coating; a solvent-based clear coating; a water-based clear coating; a radiation curable clear coating; an adhesive; a pressure sensitive adhesive; a radiation curable adhesive; a wax material; and a UV screen matte doming compound.

15. The article of claim 1, wherein the removable concealing layer is opaque.

16. The article of claim 1, wherein the removable concealing layer comprises one selected from the group consisting of: an opaque material; a wax material; a foil; a hot stamp foil; a pigment foil; a metallic foil; an opaque ink; a flexographic ink; a lithographic ink; a silk screen ink; a film; a foil-coated label; an ink-coated label; and an adhesive material.

17. The article of claim 16, wherein any of the opaque ink, the flexographic ink, the lithographic ink, the silk screen ink, the film, the foil-coated label, the ink-coated label, and the adhesive material are radiation curable, solvent-based curable, or water-based curable.

18. The article of claim 1, wherein the article further comprises at least one selected from the group consisting of: a magnetic stripe, a bar code, and a radio frequency identification (RFID) tag.

19. The article of claim 1, wherein the substrate comprises at least one material selected from the group consisting of: a plastic, a laminated plastic, a paper, a coated paper, a laminated paper, a laminated synthetic paper, a cardstock, and a foil.

20. The article of claim 1, wherein at least a portion of the substrate comprises a lenticular lens.

21. A concealing system for application on a surface of an article comprising:
a doming layer adapted to tactilely obscure at least a portion of the surface of the printed article; and
a removable concealing layer applied over at least a portion of the doming layer and adapted to visually obscure at least a portion of the surface of the printed article.

22. The concealing system of claim 21, wherein the doming layer is applied in a continuous layer.

23. The concealing system of claim 21, wherein the doming layer is applied in a non-continuous layer comprising a pattern.

24. The concealing system of claim 21, wherein the doming layer comprises one selected from the group consisting of: a semi-transparent material; an opaque material; a tinted material; an ink; a clear curable ink; an extruded film; a tinted material; a clear UV silkscreen carrier, a clear UV varnish; a clear UV coating; a clear aqueous coating; a solvent-based clear coating; a water-based clear coating; a radiation curable clear coating; an adhesive; a pressure sensitive adhesive; a radiation cured adhesive; a wax material; and UV screen matte doming compound.

25. The removable concealing system of claim 21, wherein the removable concealing layer comprises one selected from the group consisting of: an opaque material; a foil; a hot stamp foil; a pigment foil; a metallic foil; an opaque ink; a flexographic ink; a lithographic ink; a silk screen ink; a film; a foil-coated label; an ink-coated label; a wax material; and an adhesive material.

26. The removable concealing system of claim 25, wherein any of the opaque ink, the flexographic ink, the lithographic ink, the silk screen ink, the film, the foil-coated label, the ink-coated label, and the adhesive material are radiation curable, solvent-based curable, or water-based curable.

27. A method of printing an article comprising the steps of:
printing indicia on a surface of the article;
tactilely obscuring at least a portion of the indicia by applying a doming layer over at least a portion of the indicia; and
visually obscuring at least a portion of the indicia by applying a removable concealing layer over at least a portion of the doming layer.

28. The method of claim 27, wherein the step of printing the indicia further comprises printing the indicia on a surface of the article by an inkjet printing process.

29. The method of claim 28, further comprising the step of:
curing the indicia printed on the surface of the article.

30. The method of claim 29, wherein the step of curing further comprises radiation curing the indicia printed on the surface of the article.

31. The method of claim 28, wherein the step of printing the indicia further comprises printing the indicia on a surface of the article by a drop-on-demand (DOD) inkjet printing process.

32. The method of claim 31, further comprising the step of:
radiation curing the indicia printed on the surface of the article.

33. The method of claim 27, further comprising the step of:
curing at least one of the doming layer and the removable concealing layer.

34. The method of claim 27, wherein applying a doming layer over at least a portion of the indicia further comprises applying the doming layer in a continuous layer.

35. The method of claim 27, wherein applying a doming layer over at least a portion of the indicia further comprises applying the doming layer in a non-continuous layer comprising a pattern.

36. The method of claim 27, wherein applying a removable concealing layer over at least a portion of the doming layer further comprises applying the removable concealing layer in a continuous layer.

37. The method of claim 27, wherein applying a removable concealing layer over at least a portion of the doming layer further comprises applying the removable concealing layer in a non-continuous layer comprising a pattern.

38. The method of claim 27, further comprising the steps of:
applying a magnetic stripe on the article; and
encoding the magnetic stripe.

39. The method of claim 27, further comprising the step of:
post-processing the article.

40. The method of claim 27, further comprising the step of:
verifying at least one step by a camera verification station.

41. A concealing system for application on a surface of an article comprising:
a doming portion adapted to tactilely obscure at least a portion of the printed article; and
a concealing portion adapted to visually obscure at least a portion of the printed article,
wherein the doming portion and the concealing portion comprise a layer applied over at least a portion of the surface of the printed article, and wherein the layer is at least partially frictionally removable.

42. The concealing system of claim 41, wherein the doming portion comprises a label and the concealing portion comprises a frictionally removable material applied to the label.

43. The concealing system of claim 41, wherein at least one of the doming portion and the concealing portion comprises a particulate material.

44. The concealing system of claim 43, wherein the particulate material comprises at least one of flakes, granules, particles, and fibers.

45. The concealing system of claim 41, wherein at least one of the doming portion and the concealing portion is color tinted.

46. The concealing system of claim 41, wherein the layer comprises a continuous layer.

47. The concealing system of claim 41, wherein the layer comprises a non-continuous pattern.
